(19) United States
(12) Patent Application Publication
(10) Pub. No.: US 2025/0063516 A1
(43) Pub. Date: Feb. 20, 2025

(54) POWER CONTROL CONFIGURATION AND SIGNALING FOR COMMUNICATIONS WITH ENERGY HARVESTING

(71) Applicant: QUALCOMM INCORPORATED, San Diego, CA (US)

(72) Inventors: Ahmed Elshafie, San Diego, CA (US); Alexandros Manolakos, Athens (GR); Ahmed Attia Abotabl, San Diego, CA (US)

(21) Appl. No.: 18/720,589

(22) PCT Filed: Jan. 24, 2023
(86) PCT No.: PCT/US2023/061176

§ 371 Date: Jun. 14, 2024

(30) Foreign Application Priority Data
Feb. 1, 2022 (GR) 20220100094

(51) Int. Cl. H04W 52/28; H04W 52/10

(52) U.S. Cl. CPC H04W 52/28; H04W 52/10

(57) ABSTRACT

Methods, systems, and devices for wireless communications are described in which a transmitting device may determine a transmit power based on a power state of the transmitting device. A transmitting device may be configured with multiple power configurations, and a particular power configuration may be selected based on a power state and physical layer channel to be transmitted. Based on the selected power configuration, a transmit power may be determined in accordance with a transmit power procedure (e.g., an open loop power control procedure). The configuration may provide, for each physical layer channel (or reference signal), a power offset or delta that is applied in the open loop power control procedure.

### CROSS REFERENCES

The present Application is a 371 national stage filing of International PCT Application No. PCT/US2023/061176 by ELSHAFIE et al. entitled “POWER CONTROL CONFIGURATION AND SIGNALING FOR COMMUNICATIONS WITH ENERGY HARVESTING,” filed Jan. 24, 2023; and claims priority to Greek patent application No. 20220100094 by ELSHAFIE et al. entitled “POWER CONTROL CONFIGURATION AND SIGNALING FOR COMMUNICATIONS WITH ENERGY HARVESTING,” filed Feb. 1, 2022, each of which is assigned to the assignee hereof, and each of which is expressly incorporated by reference in its entirety herein.

### FIELD OF TECHNOLOGY

The following relates to wireless communications, including power control configuration and signaling for communications with energy harvesting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may be configured to harvest energy from one or more signals received from another device (e.g., another UE or a base station). Improved techniques for facilitating energy harvesting in a wireless communications system may be desirable.

### SUMMARY

The described techniques relate to improved methods, systems, devices, and apparatuses that support power control configuration and signaling for communications with energy harvesting. A transmitting device, such as a transmitting user equipment (UE), may receive different configurations for determining a transmit power based on an energy state of the device. The different configurations may include, for example, a first power control configuration and a second power control configuration that have different parameters for determining (e.g., calculating) the transmit power based on a first power control offset associated with a first power state of the device and a second power control offset associated with a second power state of the device. In some cases, the first power state may be associated with an energy harvesting power state, and the second power state may be associated with a non-energy harvesting power state. Additionally, or alternatively, the first power state and the second power state may correspond to one or more of a battery level of the device, a number of processes associated with sidelink or access link communications, one or more other operational states of the device, or any combinations thereof. In some aspects, the device may provide an indication of a capability associated with different power control parameters associated with different power states, such that a second device (e.g., a base station or other UE in sidelink communications) may configure transmit powers in accordance with the indicated capabilities.

A method for wireless communication at a first device is described. The method may include receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state, determining a first transmission power for a first transmission on the first physical layer channel based on the first device being in the first power state or the second power state, and transmitting the first transmission on the first physical layer channel according to the first transmission power.

An apparatus for wireless communication at a first device is described. The apparatus may include a processor, memory coupled with the processor, and instructions stored in the memory. The instructions may be executable by the processor to cause the apparatus to receive control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state, determine a first transmission power for a first transmission on the first physical layer channel based on the first device being in the first power state or the second power state, and transmit the first transmission on the first physical layer channel according to the first transmission power.

Another apparatus for wireless communication at a first device is described. The apparatus may include means for receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state, means for determining a first transmission power for a first transmission on the first physical layer channel based on the first device being in the first power state or the second power state, and means for transmitting the first transmission on the first physical layer channel according to the first transmission power.

A non-transitory computer-readable medium storing code for wireless communication at a first device is described. The code may include instructions executable by a processor to receive control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state, determine a first transmission power for a first transmission on the first physical layer channel based on the first device being in the first power state or the second power state, and transmit the first transmission on the first physical layer channel according to the first transmission power.

In some examples of the method, apparatuses, and non-transitory computer-readable medium described herein, the first power state corresponds to a first energy harvesting mode of the first device, and the second power state corresponds to a second energy harvesting mode of the first device. In some examples of the method, apparatuses, and non-transitory computer-readable medium described herein, the receiving the control signaling may include operations, features, means, or instructions for receiving, for each of the set of multiple physical layer channels, a separate power control configuration for each of the first power state and the second power state. In some examples of the method, apparatuses, and non-transitory computer-readable medium described herein, the control signaling may be received in radio resource control (RRC) signaling, in a medium access control (MAC) control element, in downlink control information, or in a shared channel message, received via an access link or a sidelink connection.

In some examples of the method, apparatuses, and non-transitory computer-readable medium described herein, the first power state and the second power state correspond to one or more of a battery level of the first device, an energy harvesting mode of the first device, a number of processes associated with sidelink or access link communications, or any combinations thereof. In some examples of the method, apparatuses, and non-transitory computer-readable medium described herein, the first power control configuration and the second power control configuration each provide a positive power control offset, a negative power control offset, or no power control offset, to an open loop power control transmit power based on a power state of the first device. In some examples of the method, apparatuses, and non-transitory computer-readable medium described herein, the control signaling may be received from a serving base station, or from a primary UE of a sidelink connection at the first device.

In some examples of the method, apparatuses, and non-transitory computer-readable medium described herein, the determining may include operations, features, means, or instructions for computing a transmit power based on an open loop power control procedure, where a pathloss parameter or pathloss factor of the open loop power control procedure is adjusted based on the first power control configuration or the second power control configuration. In some examples of the method, apparatuses, and non-transitory computer-readable medium described herein, a transmit power limit, a target transmit power, or any combinations thereof, may be adjusted based on the first power control configuration or the second power control configuration, and where the transmit power limit and the target transmit power each have a different power control configuration. In some examples of the method, apparatuses, and non-transitory computer-readable medium described herein, two or more physical layer channels may be grouped in a first channel group, and where the first power control configuration applies to each channel in the first channel group based on the first device being in the first power state, and the second power control configuration applies to each channel in the first channel group based on the first device being in the second power state.

Some examples of the method, apparatuses, and non-transitory computer-readable medium described herein may further include operations, features, means, or instructions for receiving two or more classes of power control configurations and receiving an indication for each of the set of multiple physical layer channels of an associated class of the physical layer channel. In some examples of the method, apparatuses, and non-transitory computer-readable medium described herein, the control signaling may be received from a serving base station and associated with access link communications of the first device, or may be associated with a pool of sidelink resources for sidelink communications between the first device and one or more other peer devices. In some examples of the method, apparatuses, and non-transitory computer-readable medium described herein, the control signaling may be received from a second device in a sidelink communication via a sidelink RRC message, via sidelink MAC control element, via sidelink control information, or via a dedicated sidelink shared channel message.

Some examples of the method, apparatuses, and non-transitory computer-readable medium described herein may further include operations, features, means, or instructions for transmitting a request message to a second device that indicates one or more requested power control configurations for one or more of the set of multiple physical layer channels and one or more power states of the first device. In some examples of the method, apparatuses, and non-transitory computer-readable medium described herein, the first device communicates using sidelink communications with one or more other devices using the set of multiple physical layer channels, and where a serving base station provides the control signaling for a pool of configured resources available for the sidelink communications.

A method for wireless communication is described. The method may include receiving, from a first device, an indication of a capability to operate in set of multiple power states, the set of multiple power states including at least a first power state in which the first device has a first level of available power and a second power state in which the first device has a second level of available power that is different than the first level of available power and transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

An apparatus for wireless communication is described. The apparatus may include a processor, memory coupled with the processor, and instructions stored in the memory. The instructions may be executable by the processor to cause the apparatus to receive, from a first device, an indication of a capability to operate in set of multiple power states, the set of multiple power states including at least a first power state in which the first device has a first level of available power and a second power state in which the first device has a second level of available power that is different than the first level of available power and transmit control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

Another apparatus for wireless communication is described. The apparatus may include means for receiving, from a first device, an indication of a capability to operate in set of multiple power states, the set of multiple power states including at least a first power state in which the first device has a first level of available power and a second power state in which the first device has a second level of available power that is different than the first level of available power and means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

A non-transitory computer-readable medium storing code for wireless communication is described. The code may include instructions executable by a processor to receive, from a first device, an indication of a capability to operate in set of multiple power states, the set of multiple power states including at least a first power state in which the first device has a first level of available power and a second power state in which the first device has a second level of available power that is different than the first level of available power and transmit control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

In some examples of the method, apparatuses, and non-transitory computer-readable medium described herein, the first power state corresponds to a first energy harvesting mode of the first device, and the second power state corresponds to a second energy harvesting mode of the first device. In some examples of the method, apparatuses, and non-transitory computer-readable medium described herein, the transmitting the control signaling may include operations, features, means, or instructions for transmitting, for each of the set of multiple physical layer channels, a separate power control offset for each of at least the first power state and the second power state. In some examples of the method, apparatuses, and non-transitory computer-readable medium described herein, the first power state and the second power state correspond to one or more of a battery level of the first device, an energy harvesting mode of the first device, a number of processes associated with sidelink or access link communications, or any combinations thereof. In some examples of the method, apparatuses, and non-transitory computer-readable medium described herein, two or more physical layer channels may be grouped in a first channel group, and where the first power control configuration applies to each channel in the first channel group based on the first device being in the first power state, and the second power control configuration applies to each channel in the first channel group based on the first device being in the second power state.

In some examples of the method, apparatuses, and non-transitory computer-readable medium described herein, the transmitting the control signaling may include operations, features, means, or instructions for transmitting two or more classes of power control offsets and transmitting an indication for each of the set of multiple physical layer channels of an associated class of the physical layer channel. In some examples of the method, apparatuses, and non-transitory computer-readable medium described herein, the first device communicates using sidelink communications with one or more other devices using the set of multiple physical layer channels, and where the control signaling provides a pool of configured resources available for the sidelink communications.

### BRIEF DESCRIPTION OF THE DRAWINGS

FIG. 1 illustrates an example of a wireless communications system that supports power control configuration and signaling for communications with energy harvesting in accordance with aspects of the present disclosure.

FIG. 2 illustrates an example of a wireless communications system that supports power control configuration and signaling for communications with energy harvesting in accordance with aspects of the present disclosure.

FIG. 3 illustrates an example of a different energy harvesting schemes in accordance with aspects of the present disclosure.

FIG. 4 illustrates an example of a process flow that supports power control configuration and signaling for communications with energy harvesting in accordance with aspects of the present disclosure.

FIGS. 5 and 6 show block diagrams of devices that support power control configuration and signaling for communications with energy harvesting in accordance with aspects of the present disclosure.

FIG. 7 shows a block diagram of a communications manager that supports power control configuration and signaling for communications with energy harvesting in accordance with aspects of the present disclosure.

FIG. 8 shows a diagram of a system including a device that supports power control configuration and signaling for communications with energy harvesting in accordance with aspects of the present disclosure.

FIGS. 9 and 10 show block diagrams of devices that support power control configuration and signaling for communications with energy harvesting in accordance with aspects of the present disclosure.

FIG. 11 shows a block diagram of a communications manager that supports power control configuration and signaling for communications with energy harvesting in accordance with aspects of the present disclosure.

FIG. 12 shows a diagram of a system including a device that supports power control configuration and signaling for communications with energy harvesting in accordance with aspects of the present disclosure.

FIGS. 13 through 17 show flowcharts illustrating methods that support power control configuration and signaling for communications with energy harvesting in accordance with aspects of the present disclosure.

### DETAILED DESCRIPTION

Some wireless communications systems may support wireless devices (e.g., user equipment (UE)) that may operate in different power states, where available power for transmissions of the wireless devices may be different depending upon the power state in which the device is operating. For example, some wireless communications systems may support devices that have an energy harvesting mode where some or all of the operating power of a device may be provided wirelessly. For example, an energy harvesting circuit at a UE may receive energy harvesting signals from a base station or another UE, and may draw energy from the signals for charging. In other cases, devices may operate in a lower power state (e.g., if a battery of the device is low), in which available power is limited. Based on the power state of a device, it may be beneficial to transmit signals using different power levels. In some cases, transmission power may be determined (e.g., calculated) based on an open loop power control procedure. For example, it may be beneficial for different uplink transmission powers to be used for certain physical (PHY) layer channels (e.g., physical uplink control channel (PUCCH) or physical sidelink control channel (PSCCH) transmissions may be able to use relatively lower powers compared to shared channel transmissions such as physical uplink shared channel (PUSCH) or physical sidelink shared channel (PSSCH) transmissions) based on a power state (e.g. an energy harvesting mode) of the device. However, existing open loop power control techniques provide separate signaling in each instance where transmit powers are to be adjusted. Various techniques as described herein provide for different power configurations that are to be used in power control techniques based on a power state (also referred to as an “energy state” or a “power/energy state”) and PHY layer channel to be transmitted.

As described herein, a wireless communications system may support efficient techniques for determining a transmit power based on the PHY layer channel to be transmitted and a power state of the device. In some cases, a transmitting UE may receive different configurations for determining a first transmit power. For example, a UE or other transmitting device may be configured with multiple power configurations, and a particular power configuration may be selected based on a power state and PHY layer channel to be transmitted (e.g., PUCCH, PUSCH, PSCCH, PSSCH, sounding reference signal (SRS), positioning reference signal (PRS), one or more sidelink reference signals). Based on the selected power configuration, an uplink or sidelink transmit power may be determined in accordance with a transmit power procedure (e.g., an open loop power control procedure). In some cases, a serving base station in access link communications, or a primary UE in sidelink communications, may transmit configuration information to a UE for open loop power control. The configuration information may configure, for each PHY layer channel or reference signal, a power offset or delta that is applied as a separate parameter in the open loop power control scheme, or that can be added to a pathloss parameter or factor in the open loop power control scheme. In some cases, the serving base station or primary UE may bundle or group PHY layer channels to have a same power configuration. Additionally or alternatively, multiple classes of configurations may be configured and one assigned to each PHY layer channel. Further, for sidelink communications, the power configurations may be configured per sidelink resource pool. In some cases, a UE or other device (e.g., an Internet-of-Things (IoT) device) may transmit one or more of capability information or a requested power control configuration for different power states and PHY layer channels.

Aspects of the disclosure are initially described in the context of wireless communications systems. Examples of processes and signaling exchanges that support power control configuration and signaling are then described. Aspects of the disclosure are further illustrated by and described with reference to apparatus diagrams, system diagrams, and flowcharts that relate to power control configuration and signaling for communications with energy harvesting.

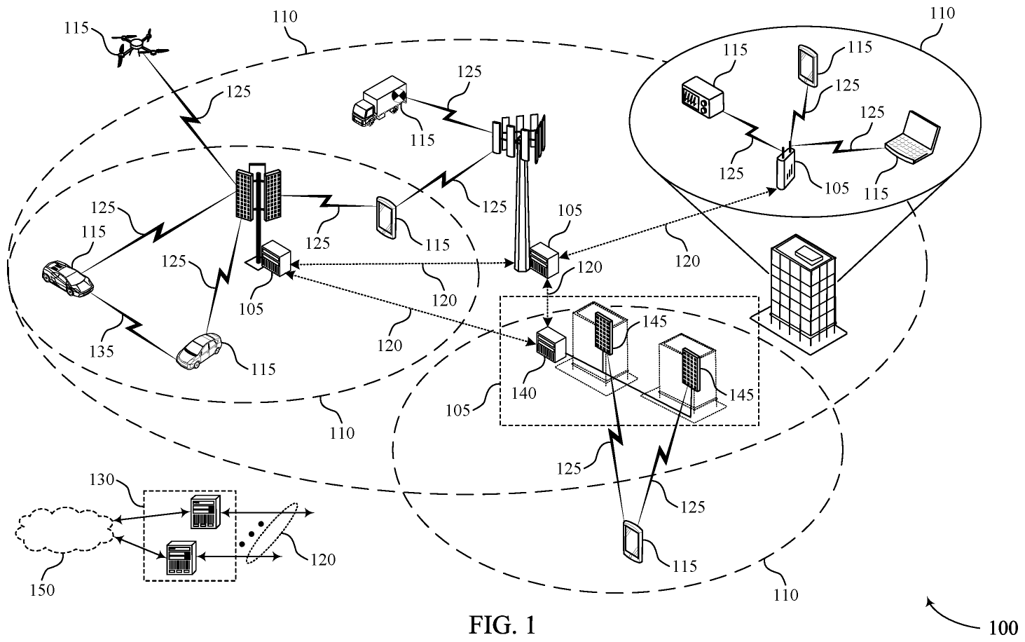

FIG. 1 illustrates an example of a wireless communications system 100 that supports power control configuration and signaling for communications with energy harvesting in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna array's or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, wireless communications system 100 may support energy harvesting at a UE 115 to facilitate wireless charging of the UE 115. Energy harvesting may allow for a longer battery life of a device with a battery or may be used to support devices without batteries (e.g., medical sensors, implanted sensors, etc.). An energy harvesting circuit at the UE 115 may receive energy harvesting signals from a base station 105 or a UE 115 and may draw energy from the signals for charging. In some examples, harvested energy may be used in some tasks like data decoding, data reception, data encoding, or data transmission (e.g., through the accumulation of energy over time). A device may use a dedicated battery for energy harvesting in a way that these tasks may be performed using the harvested energy. In some examples, energy harvesting may be used to charge the battery of a device (e.g., wearable smart watch, UE, low-power device, etc.). In some cases, harvesting RF energy may be used to provide power for some tasks, such as data decoding, data reception, data encoding, data transmission, and the like. In such cases, energy harvesting may not be intended to charge a device battery in full, but instead may be intended to provide power for the device in a way that some tasks can be performed using the harvested energy. Such operation may be referred to as a self-sustainable network where a node in the network may interact with other devices in the network using energy harvested in the network through transmissions.

Energy harvesting using signals or radio frequency (RF) signals may be referred to as RF energy harvesting. Unlike energy harvesting from other sources (e.g., wind, solar, or vibrations), RF energy harvesting may be facilitated by RF sources that can provide controllable and consistent energy transfer over distances between devices for RF energy harvesters. Further, in a fixed RF energy harvesting network, harvested energy may be predictable and relatively stable over time due to a fixed distance between a transmitter and a receiver. When operating in an energy harvesting mode, it may be desirable for a device to use different transmit power levels than in cases where the device is in a different operation mode.

In some cases, wireless communications system 100 may support efficient techniques for determining a transmit power based on the PHY layer channel to be transmitted and a power state of the device. In some cases, a UE 115 (or other transmitting device) may be configured with multiple power control configurations, and a particular power control configuration may be selected based on a power state and PHY layer channel to be transmitted. Based on the selected power control configuration, an uplink or sidelink transmit power may be determined in accordance with a transmit power procedure (e.g., an open loop power control procedure based on a power offset indicated in a respective power control configuration). In some cases, a serving base station 105 in access link communications, or a primary UE 115 in sidelink communications, may transmit configuration information to a transmitting UE 115 for open loop power control. The configuration information may configure, for each PHY layer channel or reference signal, a power offset or delta that is applied as a separate parameter in the open loop power control scheme, or that can be added to a pathloss parameter or factor in the open loop power control scheme.

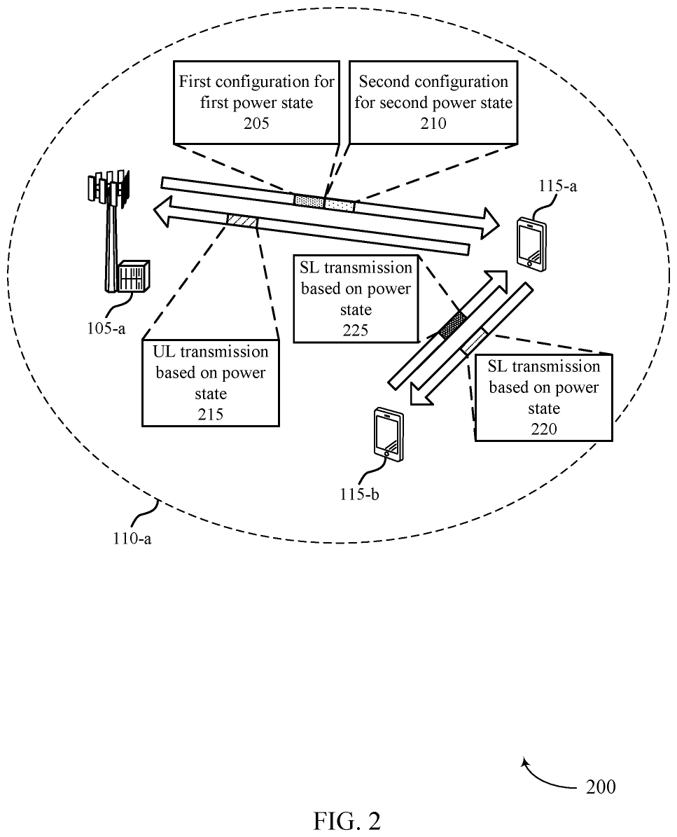

FIG. 2 illustrates an example of a wireless communications system 200 that supports power control configuration and signaling for communications with energy harvesting in accordance with aspects of the present disclosure. The wireless communications system 200 includes a first UE 115-a and a second UE 115-b, which may be examples of UEs 115 described with reference to FIG. 1. The wireless communications system 200 also includes a base station 105-a, which may be an example of a base station 105 described with reference to FIG. 1. The base station 105-a may provide communication coverage for UEs 115 in a geographic coverage area 110-a, which may be an example of a geographic coverage area 110 described with reference to FIG. 1. The wireless communications system 200 may support efficient techniques for determining a transmit power based on a UE 115 power state.

Base station 105-a may transmit a first configuration 205 (e.g., transmit power configuration) to the first UE 115-a for determining a first transmit power in a first power state, and the base station 105-a may transmit a second configuration 210 to the first UE 115-a for determining a second transmit power in a second power state. In some cases, the first configuration 205 and the second configuration 210 may include different power control offsets or deltas that are provided with open loop power control parameters. Each of these configurations may indicate one or more different parameters for determining a transmit power. That is, the wireless communications system 200 may support different (e.g., new) transmit power parameters, and the transmit power determined based on a power state of the transmitting device. In some cases, the first UE 115-a may provide the configuration information to the second UE 115-b (e.g., in accordance with a sidelink configuration), or in other cases the second UE 115-b may receive the configuration information from the base station 105-a (e.g., in separate configuration information signaling from the first UE 115-a or in common signaling that is transmitted to multiple UEs 115). The first UE 115-a may transmit an uplink transmission 215 to the base station 105-a based on a power state of the first UE 115-a and the associated configuration information for the power state. Further, in some cases, the first UE 115-a may transmit sidelink transmission 220 to the second UE 115-b based on a power state of the first UE 115-a and the associated configuration information for the power state, and likewise the second UE 115-b may transmit sidelink transmission 225 to the first UE 115-a based on a power state of the second UE 115-b and the associated configuration information for the power state.

In some cases, one or both the first UE 115-a and the second UE 115-b may be energy harvester devices that have low power capability (e.g., they may be IoT devices that obtain operating power at least partially through energy harvesting). While various examples describe devices that operate in energy harvesting power modes, techniques as discussed herein may be applied in other cases as well, in which it may be desirable to operate a device in a low power mode (e.g., if a UE 115 is in a low battery state and substantial power reductions are implemented to conserve at least a small amount of communications capability). Power control techniques as discussed herein thus may be implemented in a number of different scenarios in which it may be desirable for a transmitting device to determine transmit power parameters based on a particular power state of the device. The different power states of devices may correspond to, for example, energy harvesting levels from an energy harvesting source (e.g., solar, vibration, wireless/RF), battery levels such as a maximum value and status, a number of energy harvesting techniques that are being engaged, a type of link used for communications (e.g., sidelink or access link communications) and associated quantities of transmissions, or any combinations thereof. In accordance with various techniques discussed herein, instead of signaling different power control parameters frequently, multiple different power control offsets may be provided, and a particular offset selected based on a power state of the transmitting device. In such cases, once a UE 115 (or other transmitting device) determines its power state, the corresponding power control parameters may be loaded and used for transmit power control.

In some cases, for each of two or more power states of a transmitting device, a configuration may indicate separate power control parameters. For example, for each energy harvesting mode of a UE 115 (e.g., energy harvesting enabled/disabled, a number of different concurrent energy harvesting operations, etc.), separate power control parameters may be used to determine transmit power. Further, in some cases, power control parameters may be provided for each power state and for each PHY channel (e.g., PxCCH, PxSCH, SRS, PRS, sidelink reference signal (SL-RS), SL-PRS). The configuration information may be provided, for example, via an access link (e.g., a Uu link between base station 105-a and one or both UEs 115), via a sidelink (e.g., a PC5 link between different UEs 115), using RRC signaling, a medium access control (MAC) control element (CE), downlink control information (DCI), sidelink control information (SCI), dedicated shared channel signaling (e.g., dedicated PSSCH in sidelink), or any combinations thereof. In some cases, for each channel or reference signal for access link transmissions (e.g., SRS, PUCCH, PUSCH, PRS) or sidelink transmissions (e.g., PSSCH, PSCCH, physical sidelink feedback channel (PSFCH), SL-RS, SL-PRS) the UEs 115 may be configured with a delta or power control offset (e.g., a positive value, negative value, or zero) in power based on the power state at the UE.

In some cases, the power control configurations may have an offset defined for max (a, b) where a first offset (e.g., Δ₁) is applied to a, and a second offset (e.g., Δ₂) is applied to b, where a is the power control formula without applying the maximum power and b is the maximum value. In some cases, there may be a and b values for each power state, then as an example, the first and second offsets are used based on the power state and associated power control configuration. In some cases, multiple power control configurations may be provided per power state, and one of the configurations for a power state may be selected based on an indication using layer 1 (L1) signaling (e.g., physical layer signaling), layer 2 (L2) signaling (e.g., a MAC-CE), or layer 3 (L3) signaling (e.g., RRC signaling). Such configurations may include different power offsets, and in some cases the multiple power control configurations for each power state may include just the associated power offsets. Additionally, in some cases, one or more power control parameters may be updated or modified within an active power state (or during any time) using L1/L2/L3 signaling. For example, L1 signaling such as DCI (if the transmissions are on a Uu link or if a base station provides sidelink power control information for a PC5 link) may be used to provide the power control parameters. In other examples, L1 signaling such as SCI (e.g., SCI-1 or SCI-2 information), PSSCH, or some other L1 channel signaling may be used to provide the power control parameters via sidelink (e.g., from a controlling UE, primary UE, or other controller: or from a receiving UE that adjusts the power control configuration). Examples of L2 or L3 signaling may include RRC or MAC-CE signaling for Uu links, and sidelink RRC or MAC-CE signaling for PC5 links.

In some cases, the delta or offset may have a different value for different power states (e.g., different energy harvesting modes, battery levels, or number of tasks being performed, at the transmitting UE 115). Further, the delta or offset may have values that depend on channel type (e.g., PxCCH, PxSCH, SRS, PRS, SL-RS, SL-PRS). For example, an open loop power control determination for uplink or sidelink shared channel transmissions (e.g., PUSCH or PSSCH, which may be referred to as PxSCH) may be based on:

$${P}_{P x S C H} ( j , q , l ) = min \{ \begin{matrix}{P}_{CMAX}^{EH - mode} , \\ \begin{matrix}{P}_{O \_ PxSCH}^{EH - mode} ( j ) + 10 \cdot {log}_{10} ( {2}^{μ} \cdot {M}_{RB}^{PxSCH} ) + \\ {α}^{EH - mode} ( j ) \cdot {PL}^{EH - mode} ( q ) + Other param - Δ\end{matrix}\end{matrix} \} ,$$

where j is a parameter set configuration index, q is a reference signal index, and l is a PUSCH power control adjustment index; P_{CMAX}^{EH-mode} is a configured maximum UE output power in energy harvesting mode, p_{O_PxSCH}^{EH-mode} is an open loop power control parameter for controlling a received power level in energy harvesting mode, M is a bandwidth of the PxSCH resource assignment, α^{EH-mode} is a pathloss (PL) compensation scaling factor which may be referred to herein as ‘alpha,’ PL is a PL value based on a measured reference signal, Other param is one or more other open loop power control parameters, and Δ is the delta or offset that is applied based on the power state of the transmitting device. In some cases, different values for A may be configured and selected by the transmitting device based on the power state of the device. In some cases, the value of A may be applied to the pathloss parameter alpha or pathloss factor PL. In other cases, P_{CMAX}^{EH-mode} and p_{O_PxSCH}^{EH-mode}(j) may take A into account, and the transmitting device may determine such values by applying the configured delta or offset associated with the power state of the device. In some cases, separate delta or offset values are provided for P_{CMAX}^{EH-mode} and p_{O_PxSCH}^{EH-mode}(j).

In some cases, the base station 105-a (or UE 115-a when acting as a primary UE in sidelink communications) may bundle or group two or more PHY channels together that have a same delta or offset. Additionally or alternatively, multiple classes of deltas of offsets may be configured, and then one of them is assigned to each PHY channel. For example, configuration could be done by the base station 105-a using RRC or a MAC-CE, or every configured sidelink resource pool (e.g., that are RRC configured by base station 105-a or relayed to out of coverage UEs by in coverage UEs). In some cases, for sidelink communications, each pair of UEs 115 can communicate these parameters through RRC, through MAC-CE, or in SCI (i.e., SCI 2) or dedicated PSSCH. In some cases, one or both of the first UE 115-a or the second UE 115-b may provide a capability for applying different power control parameters based on a power state. Additionally, in some cases one or both UEs 115 may report a recommendation on power control parameters for each power state and PHY channel (e.g., in an capability report or uplink control information (UCI), or in SCI). In some sidelink configurations, the base station 105-a may assign power configurations per power mode of the transmitting device, per PHY channel, per resource pool, across resource pools, or any combinations thereof.

While the above examples reference open loop power control parameters that are applied to PxSCH channels based on a power mode of the transmitting device, similar techniques may be used for communications on other PHY channels or for reference signal transmissions. For example, the UEs 115 may determine a transmit power for transmitting sounding reference signals (SRSs) using equation:

$${P}_{S R S} ( i , q , l ) = min ( \begin{matrix}{P}_{CMAX , f , c} ( i ) \\ \begin{matrix}{P}_{0 \_ SRS , b , f , c} ( j ) + 10 {log}_{10} ( {2}^{μ} \cdot {M}_{SRS , b , f , c} ( i ) ) + \\ {α}_{S R S} ( q ) \cdot PL ( q ) + O ther param + Δ\end{matrix}\end{matrix} ) .$$

Other channels and reference signals (e.g., PUCCH, PSCCH, PRS, SL-RS, SL-PRS) may have deltas of offsets applied in a similar manner.

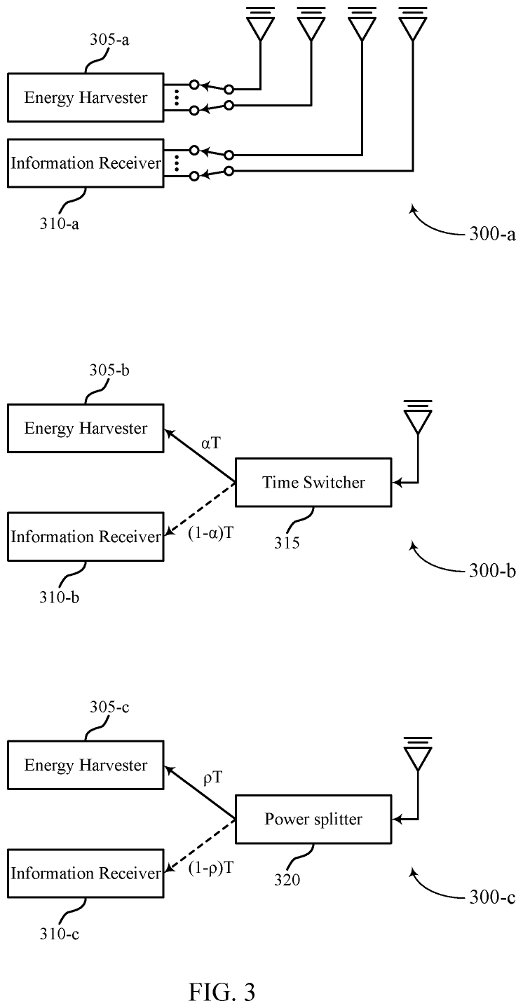

FIG. 3 illustrates an example of a different energy harvesting schemes 300 that supports power control configuration and signaling for communications with energy harvesting in accordance with aspects of the present disclosure. A first example scheme 300-a illustrates aspects of a separated receiver architecture for energy harvesting. The separated receiver architecture may include an energy harvester 305-a and an information receiver 310-a, and the energy harvester 305-a may be connected to different antennas from the information receiver 310-a. A second example scheme 300-b illustrates aspects of a time-switching architecture for energy harvesting. The time-switching architecture may include an energy harvester 305-b, an information receiver 310-b, and a time switcher 315. A third example scheme 300-c illustrates aspects of a power-splitting architecture for energy harvesting. The power-splitting architecture may include an energy harvester 305-c, an information receiver 310-c, and a power splitter 320.

The time-switching architecture may allow a node (e.g., network node, such as a UE 115) to switch between the energy harvester 305-b and the information receiver 310-b. In some cases, energy harvested at a receiver j from a source i may be calculated using the below, where 0≤α≤1 may be a fraction of time allocated for energy harvesting.

$${E}_{j} = η {P}_{i} {\vert {g}_{i - j} \vert}^{2} α T$$

In some examples, a data rate for communications using the time-switching architecture may be given by the below equation, where κ may denote a noise spectral density and W may denote a channel bandwidth.

$${R}_{i - j} = ( 1 - α ) {log}_{2} ( 1 + \frac{{\vert {g}_{i - j} \vert}^{2} {P}_{i}}{κ W} )$$

In the power-splitting architecture, received RF signals may be split into two streams for the energy harvester 305-c and the information receiver 310-c with different power levels. In some cases, energy harvested at a receiver j from a source i may be calculated using the below equation, where 0≤ρ≤1 may be a fraction of power allocated for energy harvesting.

$${E}_{j} = η ρ {P}_{i} {\vert {g}_{i - j} \vert}^{2} T$$

In some examples, a data rate for communications using the power-switching architecture may be given by the below equation, where x may denote a noise spectral density and W may denote a channel bandwidth.

$${R}_{i - j} = {log}_{2} ( 1 + \frac{{\vert {g}_{i - j} \vert}^{2} ( 1 - ρ ) {P}_{i}}{κ W} )$$

In some cases, as discussed with reference to FIG. 2, a transmitting device may determine a transmit power based on an energy harvesting mode in which it is operating, and different deltas of power control offset values may be provided for devices that are operating in one or more of these energy harvesting modes.

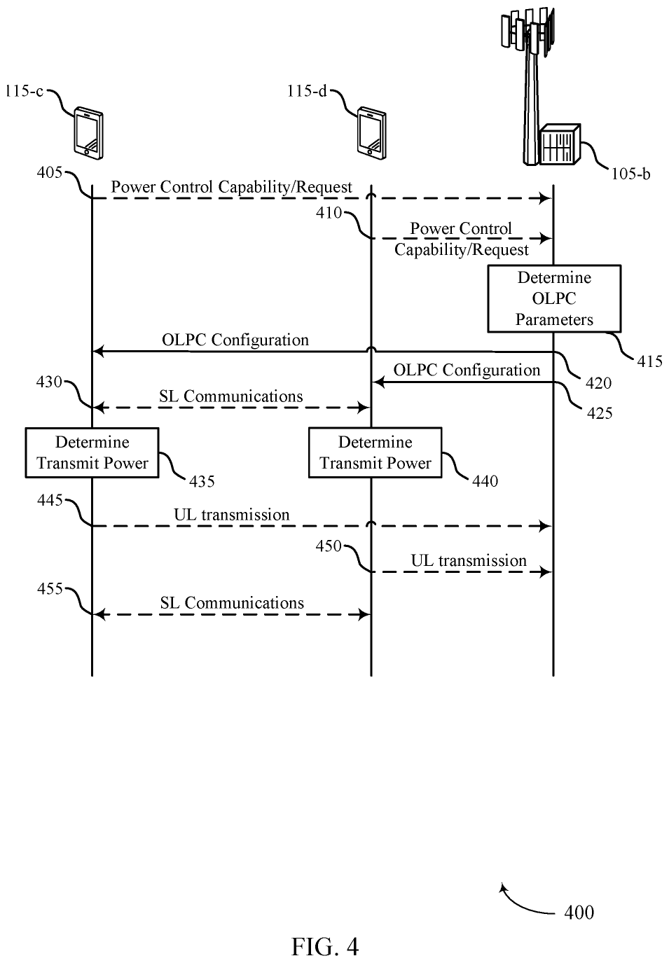

FIG. 4 illustrates an example of a process flow 400 that supports power control configuration and signaling for communications with energy harvesting in accordance with aspects of the present disclosure. Process flow 400 includes UE 115-c and UE 115-d, which may be examples of UEs 115 described with reference to FIGS. 1-3. Process flow 400 also includes a base station 105-b, which may be an example of a base station 105 described with reference to FIGS. 1-3. The process flow 400 may implement aspects of wireless communications system 100 or 200. For example, the process flow 400 may support efficient techniques for power control configuration and signaling for communications with energy harvesting.

In the following description of the process flow 400, the signaling exchanged between the UEs 115 and between the UEs 115 and the base station 105 may be exchanged in a different order than the example order shown, or the operations performed by the UEs 115 and the base station 105 may be performed in different orders or at different times. Some operations may also be omitted from the process flow 400, and other operations may be added to the process flow 400.

Optionally, at 405, the UE 115-c may transmit a power control capability indication to the base station 105-b. In some cases, a request or recommendation for one or more power control offsets may be provided to the base station 105-b. Likewise, at 410, the UE 115-d may transmit a power control capability/request to the base station 105-b. In some cases, the power control capability or request may be transmitted to the base station 105-b in RRC signaling, in a MAC-CE, in uplink control information, or any combinations thereof. In some cases, one or both of the UEs 115 may be capable of operating in multiple different power states, such as an energy harvesting state, a non-energy harvesting state, a low battery state, and the like.

At 415, the base station 105-b may determine open loop power control parameters for setting transmit powers at the UEs 115. In some cases, the open loop power control parameters may include different deltas of power control offsets that are to be applied in open loop power control calculations based on the power state of the UEs 115, based on a physical layer channel of the transmission, or any combinations thereof. At 420, the base station 105-b may transmit open loop power control configuration parameters to the UE 115-c, and at 425 the base station 105-b may transmit open loop power control configuration parameters to the UE 115-d. In some cases, the transmissions at 420 and 425 may be transmitted in a multicast transmission to both UEs 115. In some cases, one of the UEs 115 may be outside of a coverage area of the base station 105-b, and the open loop power control configuration may be relayed to the out of coverage UE or provided in SCI. In some cases, at 430, open loop power control parameters may be exchanged for sidelink communications between the UEs 115.

At 435, the UE 115-c may determine a transmit power for an upcoming transmission. Likewise, at 440, the UE 115-d determine a transmit power for an upcoming transmission. In some cases, each UE 115 may determine its transmit power based on a power state at the UE 115 (e.g., based on whether the UE 115 is operating an energy harvesting mode or a low power consumption mode), a PHY channel associated with the transmission, and the configured power control parameters (e.g., one or more deltas of offsets that are configured for the power state and PHY channel). In cases where the UEs 115 transmit uplink communications to the base station 105-b, at 445 the UE 115-c may transmit an uplink transmission to the base station 105-b, and at 450 the UE 115-d may transmit an uplink transmission to the base station 105-b. In cases where the UEs 115 communicate with each other, at 455, sidelink communications may be transmitted by each UE 115 using the determined transmit powers.

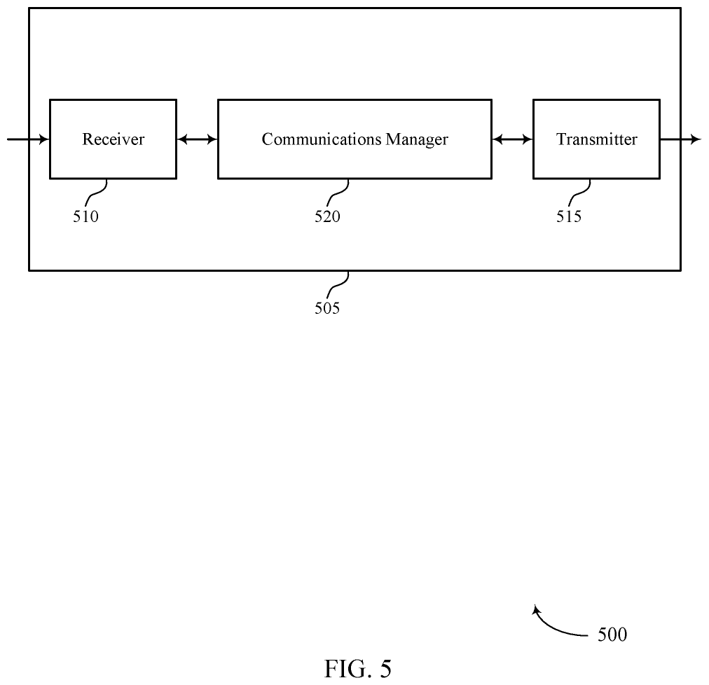

FIG. 5 shows a block diagram 500 of a device 505 that supports power control configuration and signaling for communications with energy harvesting in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to power control configuration and signaling for communications with energy harvesting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power control configuration and signaling for communications with energy harvesting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of power control configuration and signaling for communications with energy harvesting as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first device in accordance with examples as disclosed herein. For example, the communications manager 520 may be configured as or otherwise support a means for receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The communications manager 520 may be configured as or otherwise support a means for determining a first transmission power for a first transmission on the first physical layer channel based on the first device being in the first power state or the second power state. The communications manager 520 may be configured as or otherwise support a means for transmitting the first transmission on the first physical layer channel according to the first transmission power.

Additionally or alternatively, the communications manager 520 may support wireless communication in accordance with examples as disclosed herein. For example, the communications manager 520 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The communications manager 520 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for improved transmit powers for devices in different power states (e.g., in an energy harvesting state) and more efficient utilization of communication resources. In particular, because a transmitting device may be configured with different parameters for determining a transmit power for data transmissions based on a power state, the device may be able to identify a suitable power for the associated power state, thereby conserving power while also transmitting at a level that is sufficient for reliable communications for a particular physical channel or reference signal.

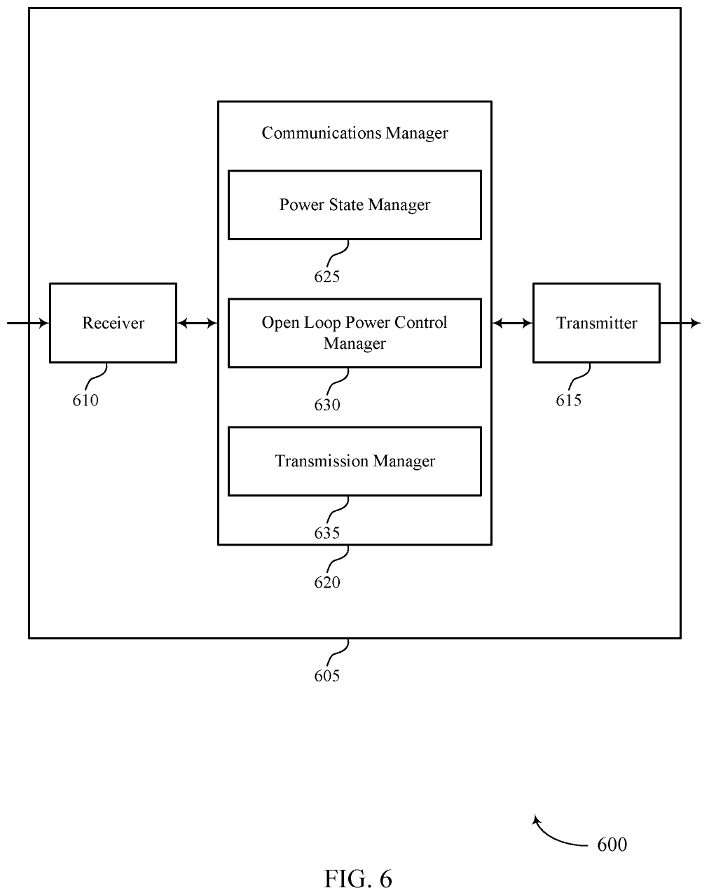

FIG. 6 shows a block diagram 600 of a device 605 that supports power control configuration and signaling for communications with energy harvesting in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power control configuration and signaling for communications with energy harvesting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power control configuration and signaling for communications with energy harvesting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power control configuration and signaling for communications with energy harvesting as described herein. For example, the communications manager 620 may include a power state manager 625, an open loop power control manager 630, a transmission manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first device in accordance with examples as disclosed herein. The power state manager 625 may be configured as or otherwise support a means for receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The open loop power control manager 630 may be configured as or otherwise support a means for determining a first transmission power for a first transmission on the first physical layer channel based on the first device being in the first power state or the second power state. The transmission manager 635 may be configured as or otherwise support a means for transmitting the first transmission on the first physical layer channel according to the first transmission power.

Additionally or alternatively, the communications manager 620 may support wireless communication in accordance with examples as disclosed herein. The power state manager 625 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The open loop power control manager 630 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

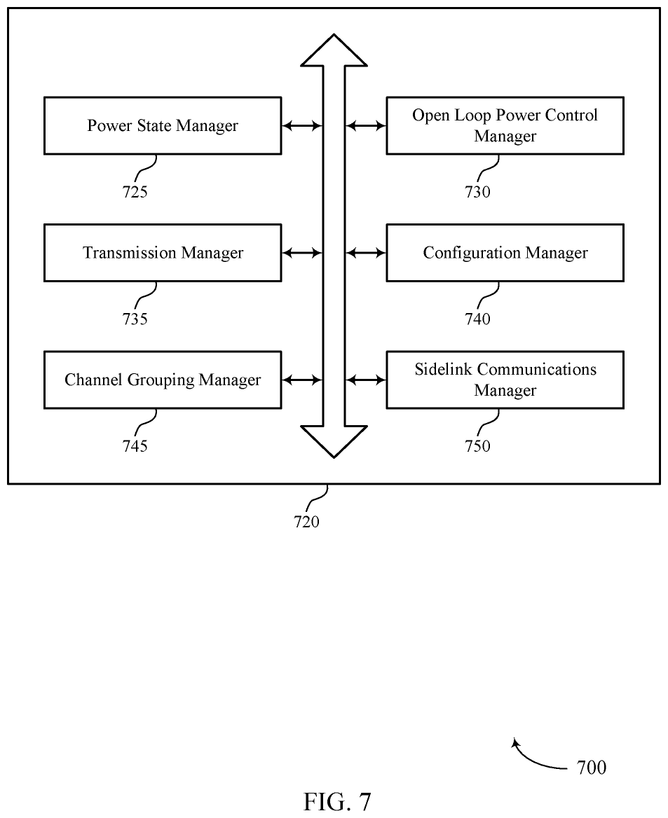

FIG. 7 shows a block diagram 700 of a communications manager 720 that supports power control configuration and signaling for communications with energy harvesting in accordance with aspects of the present disclosure. The communications manager 720 may be an example of aspects of a communications manager 520, a communications manager 620, or both, as described herein. The communications manager 720, or various components thereof, may be an example of means for performing various aspects of power control configuration and signaling for communications with energy harvesting as described herein. For example, the communications manager 720 may include a power state manager 725, an open loop power control manager 730, a transmission manager 735, a configuration manager 740, a channel grouping manager 745, a sidelink communications manager 750, or any combination thereof. Each of these components may communicate, directly or indirectly, with one another (e.g., via one or more buses).

The communications manager 720 may support wireless communication at a first device in accordance with examples as disclosed herein. The power state manager 725 may be configured as or otherwise support a means for receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The open loop power control manager 730 may be configured as or otherwise support a means for determining a first transmission power for a first transmission on the first physical layer channel based on the first device being in the first power state or the second power state. The transmission manager 735 may be configured as or otherwise support a means for transmitting the first transmission on the first physical layer channel according to the first transmission power. In some examples, the first power state corresponds to a first energy harvesting mode of the first device, and the second power state corresponds to a second energy harvesting mode of the first device.

In some examples, to support receiving the control signaling, the open loop power control manager 730 may be configured as or otherwise support a means for receiving, for each of the set of multiple physical layer channels, a separate power control configuration for each of the first power state and the second power state. In some examples, the control signaling is received in RRC signaling, in a MAC-CE, in downlink control information (DCI), or in a shared channel message, received via an access link or a sidelink connection.

In some examples, the first power state and the second power state correspond to one or more of a battery level of the first device, an energy harvesting mode of the first device, a number of processes associated with sidelink or access link communications, or any combinations thereof. In some examples, the first power control configuration and the second power control configuration each provide a positive power control offset, a negative power control offset, or no power control offset, to an open loop power control transmit power based on a power state of the first device. In some examples, the control signaling is received from a serving base station, or from a primary UE of a sidelink connection at the first device.

In some examples, to support determining, the open loop power control manager 730 may be configured as or otherwise support a means for computing a transmit power based on an open loop power control procedure, where a pathloss parameter or pathloss factor of the open loop power control procedure is adjusted based on the first power control configuration or the second power control configuration. In some examples, a transmit power limit, a target transmit power, or any combinations thereof, are adjusted based on the first power control configuration or the second power control configuration, and where the transmit power limit and the target transmit power each have a different power control offset.

In some examples, two or more physical layer channels are grouped in a first channel group, and where the first power control configuration applies to each channel in the first channel group based on the first device being in the first power state, and the second power control configuration applies to each channel in the first channel group based on the first device being in the second power state. In some examples, two or more classes of power control configurations may be received, and control signaling may provide an indication, for each of the set of multiple physical layer channels, of an associated class of the physical layer channel.

In some examples, the control signaling is received from a serving base station and is associated with access link communications of the first device, or is associated with a pool of sidelink resources for sidelink communications between the first device and one or more other peer devices. In some examples, the control signaling is received from a second device in a sidelink communication via a sidelink RRC message, via a sidelink MAC-CE, via SCI, or via a dedicated sidelink shared channel message.

In some examples, the power state manager 725 may be configured as or otherwise support a means for transmitting a request message to a second device that indicates one or more requested power control configurations for one or more of the set of multiple physical layer channels and one or more power states of the first device. In some examples, the first device communicates using sidelink communications with one or more other devices using the set of multiple physical layer channels, and where a serving base station provides the control signaling for a pool of configured resources available for the sidelink communications.

Additionally or alternatively, the communications manager 720 may support wireless communication in accordance with examples as disclosed herein. In some examples, the power state manager 725 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. In some examples, the open loop power control manager 730 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state. In some examples, the first power state corresponds to a first energy harvesting mode of the first device, and the second power state corresponds to a second energy harvesting mode of the first device.

In some examples, to support transmitting the control signaling, the configuration manager 740 may be configured as or otherwise support a means for transmitting, for each of the set of multiple physical layer channels, a separate power control configuration for each of at least the first power state and the second power state. In some examples, the first power state and the second power state correspond to one or more of a battery level of the first device, an energy harvesting mode of the first device, a number of processes associated with sidelink or access link communications, or any combinations thereof.

In some examples, two or more physical layer channels are grouped in a first channel group, and where the first power control configuration applies to each channel in the first channel group based on the first device being in the first power state, and the second power control configuration applies to each channel in the first channel group based on the first device being in the second power state.

In some examples, to support transmitting the control signaling, the open loop power control manager 730 may be configured as or otherwise support a means for transmitting two or more classes of power control configurations. In some examples, to support transmitting the control signaling, the open loop power control manager 730 may be configured as or otherwise support a means for transmitting an indication for each of the set of multiple physical layer channels of an associated class of the physical layer channel. In some examples, the first device communicates using sidelink communications with one or more other devices using the set of multiple physical layer channels, and where the control signaling provides a pool of configured resources available for the sidelink communications.

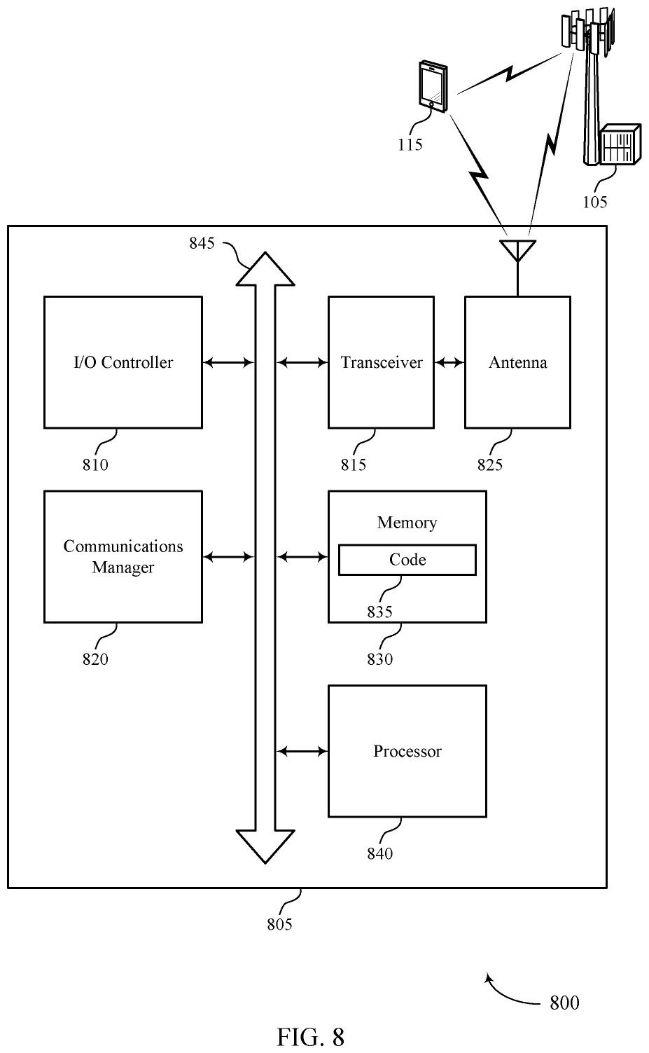

FIG. 8 shows a diagram of a system 800 including a device 805 that supports power control configuration and signaling for communications with energy harvesting in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2R, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting power control configuration and signaling for communications with energy harvesting). For example, the device 805 or a component of the device 805 may include a processor 840 and memory 830 coupled to the processor 840, the processor 840 and memory 830 configured to perform various functions described herein.

The communications manager 820 may support wireless communication at a first device in accordance with examples as disclosed herein. For example, the communications manager 820 may be configured as or otherwise support a means for receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The communications manager 820 may be configured as or otherwise support a means for determining a first transmission power for a first transmission on the first physical layer channel based on the first device being in the first power state or the second power state. The communications manager 820 may be configured as or otherwise support a means for transmitting the first transmission on the first physical layer channel according to the first transmission power.

Additionally or alternatively, the communications manager 820 may support wireless communication in accordance with examples as disclosed herein. For example, the communications manager 820 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The communications manager 820 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

By including or configuring the communications manager 820 in accordance with examples as described herein, the device 805 may support techniques for improved transmit powers for devices in different power states (e.g., in an energy harvesting state) and more efficient utilization of communication resources. In particular, because a transmitting device may be configured with different parameters for determining a transmit power for data transmissions based on a power state, the device may be able to identify a suitable power for the associated power state, thereby conserving power while also transmitting at a level that is sufficient for reliable communications for a particular physical channel or reference signal.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of power control configuration and signaling for communications with energy harvesting as described herein, or the processor 840 and the memory 830 may be otherwise configured to perform or support such operations.

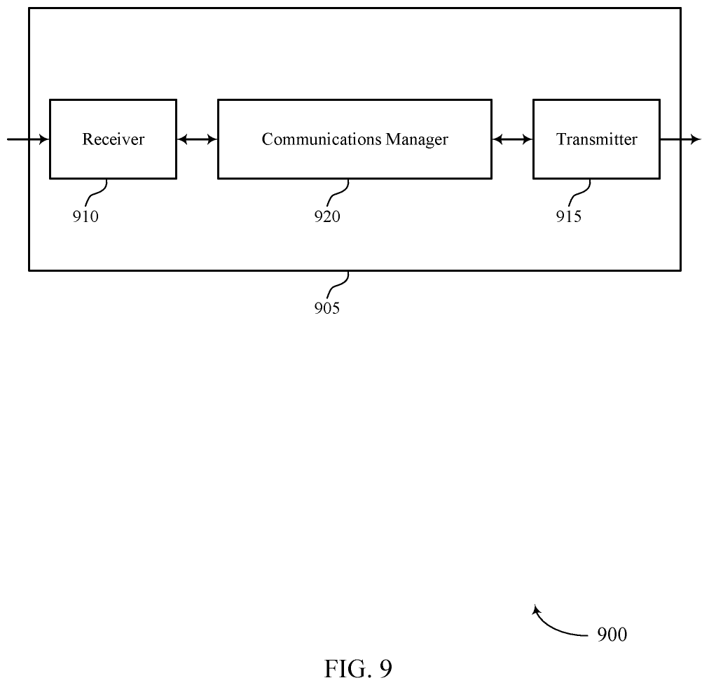

FIG. 9 shows a block diagram 900 of a device 905 that supports power control configuration and signaling for communications with energy harvesting in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to power control configuration and signaling for communications with energy harvesting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to power control configuration and signaling for communications with energy harvesting). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of power control configuration and signaling for communications with energy harvesting as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication in accordance with examples as disclosed herein. For example, the communications manager 920 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The communications manager 920 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for improved transmit powers for devices in different power states (e.g., in an energy harvesting state) and more efficient utilization of communication resources. In particular, because a transmitting device may be configured with different parameters for determining a transmit power for data transmissions based on a power state, the device may be able to identify a suitable power for the associated power state, thereby conserving power while also transmitting at a level that is sufficient for reliable communications for a particular physical channel or reference signal.

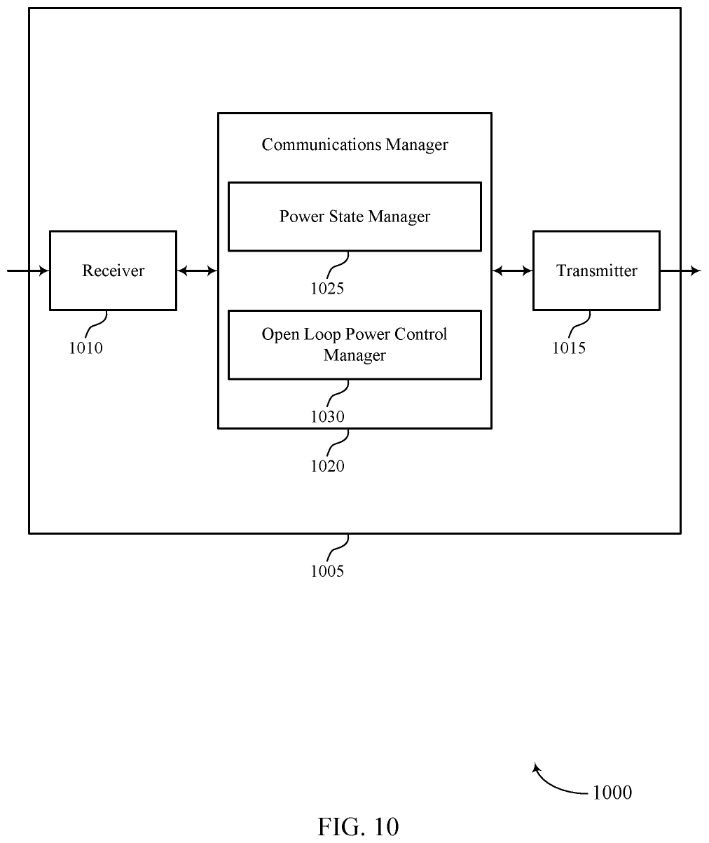

FIG. 10 shows a block diagram 1000 of a device 1005 that supports power control configuration and signaling for communications with energy harvesting in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to power control configuration and signaling for communications with energy harvesting). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to power control configuration and signaling for communications with energy harvesting). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of power control configuration and signaling for communications with energy harvesting as described herein. For example, the communications manager 1020 may include a power state manager 1025 an open loop power control manager 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication in accordance with examples as disclosed herein. The power state manager 1025 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The open loop power control manager 1030 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

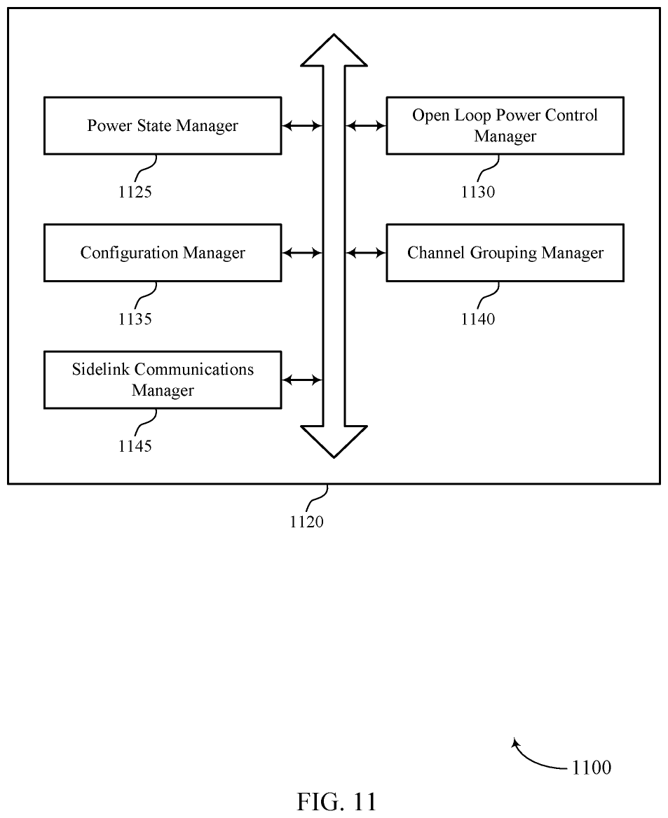

FIG. 11 shows a block diagram 1100 of a communications manager 1120 that supports power control configuration and signaling for communications with energy harvesting in accordance with aspects of the present disclosure. The communications manager 1120 may be an example of aspects of a communications manager 920, a communications manager 1020, or both, as described herein. The communications manager 1120, or various components thereof, may be an example of means for performing various aspects of power control configuration and signaling for communications with energy harvesting as described herein. For example, the communications manager 1120 may include a power state manager 1125, an open loop power control manager 1130, a configuration manager 1135, a channel grouping manager 1140, a sidelink communications manager 1145, or any combination thereof. Each of these components may communicate, directly or indirectly, with one another (e.g., via one or more buses).

The communications manager 1120 may support wireless communication in accordance with examples as disclosed herein. The power state manager 1125 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The open loop power control manager 1130 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state. In some examples, the first power state corresponds to a first energy harvesting mode of the first device, and the second power state corresponds to a second energy harvesting mode of the first device.

In some examples, to support transmitting the control signaling, the configuration manager 1135 may be configured as or otherwise support a means for transmitting, for each of the set of multiple physical layer channels, a separate power control configuration for each of at least the first power state and the second power state. In some examples, the first power state and the second power state correspond to one or more of a battery level of the first device, an energy harvesting mode of the first device, a number of processes associated with sidelink or access link communications, or any combinations thereof. In some examples, two or more physical layer channels are grouped in a first channel group, and where the first power control configuration applies to each channel in the first channel group based on the first device being in the first power state, and the second power control configuration applies to each channel in the first channel group based on the first device being in the second power state.

In some examples, to support transmitting the control signaling, the open loop power control manager 1130 may be configured as or otherwise support a means for transmitting two or more classes of power control configurations. In some examples, to support transmitting the control signaling, the open loop power control manager 1130 may be configured as or otherwise support a means for transmitting an indication for each of the set of multiple physical layer channels of an associated class of the physical layer channel. In some examples, the first device communicates using sidelink communications with one or more other devices using the set of multiple physical layer channels, and where the control signaling provides a pool of configured resources available for the sidelink communications.

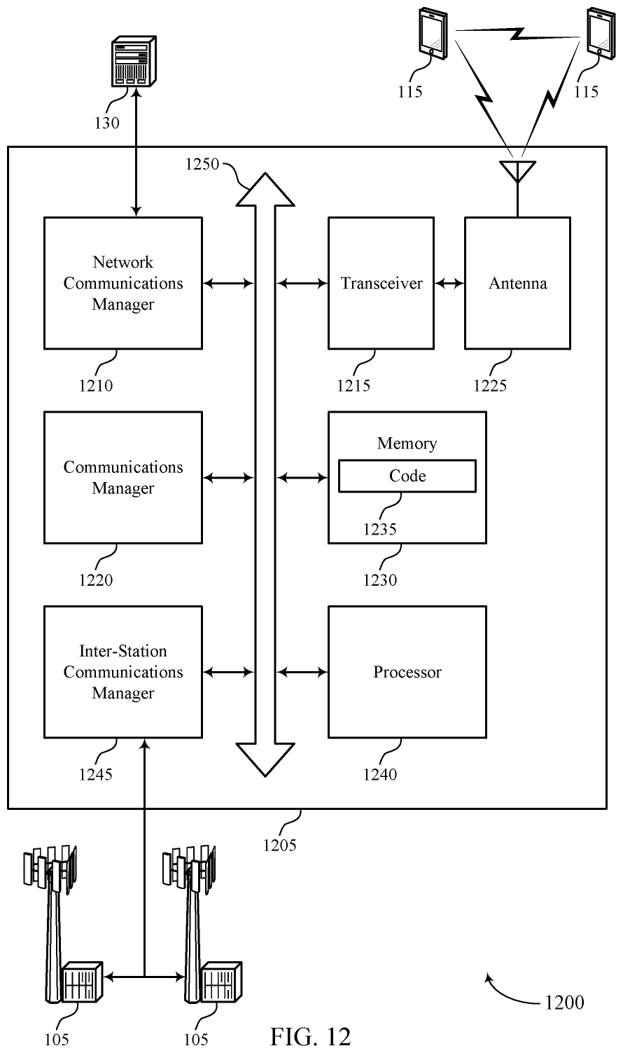

FIG. 12 shows a diagram of a system 1200 including a device 1205 that supports power control configuration and signaling for communications with energy harvesting in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting power control configuration and signaling for communications with energy harvesting). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication in accordance with examples as disclosed herein. For example, the communications manager 1220 may be configured as or otherwise support a means for receiving, from a first device, an indication of a capability to operate in set of multiple power states, the set of multiple power states including at least a first power state in which the first device has a first level of available power and a second power state in which the first device has a second level of available power that is different than the first level of available power. The communications manager 1220 may be configured as or otherwise support a means for transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state.

By including or configuring the communications manager 1220 in accordance with examples as described herein, the device 1205 may support techniques for improved transmit powers for devices in different power states (e.g., in an energy harvesting state) and more efficient utilization of communication resources. In particular, because a transmitting device may be configured with different parameters for determining a transmit power for data transmissions based on a power state, the device may be able to identify a suitable power for the associated power state, thereby conserving power while also transmitting at a level that is sufficient for reliable communications for a particular physical channel or reference signal.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of power control configuration and signaling for communications with energy harvesting as described herein, or the processor 1240 and the memory 1230 may be otherwise configured to perform or support such operations.

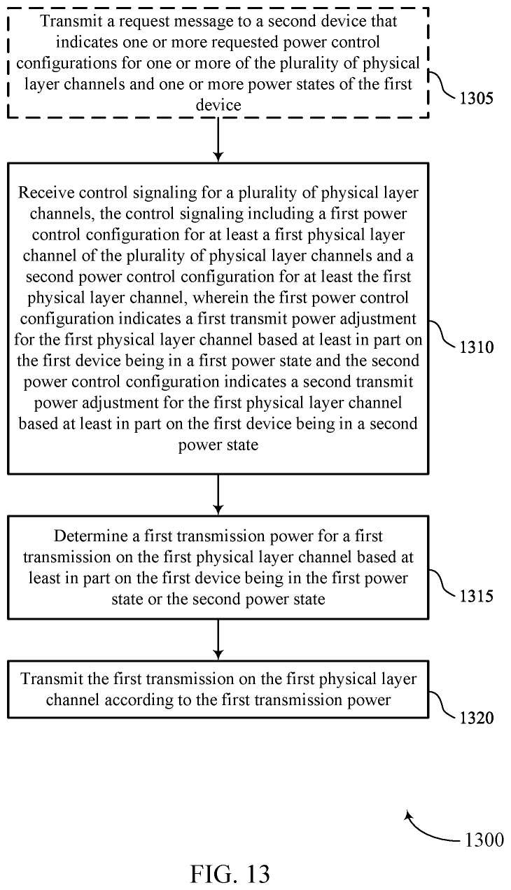

FIG. 13 shows a flowchart illustrating a method 1300 that supports power control configuration and signaling for communications with energy harvesting in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

Optionally, at 1305, the method may include transmitting a request message to a second device that indicates one or more requested power control configurations for one or more of the set of multiple physical layer channels and one or more power states of the first device. The operations of 1305 may be performed in accordance with examples as disclosed herein. In some examples, aspects of the operations of 1305 may be performed by a power state manager 725 as described with reference to FIG. 7.

At 1310, the method may include receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The operations of 1310 may be performed in accordance with examples as disclosed herein. In some examples, aspects of the operations of 1310 may be performed by a power state manager 725 as described with reference to FIG. 7.

At 1315, the method may include determining a first transmission power for a first transmission on the first physical layer channel based on the first device being in the first power state or the second power state. The operations of 1315 may be performed in accordance with examples as disclosed herein. In some examples, aspects of the operations of 1315 may be performed by an open loop power control manager 730 as described with reference to FIG. 7.

At 1320, the method may include transmitting the first transmission on the first physical layer channel according to the first transmission power. The operations of 1320 may be performed in accordance with examples as disclosed herein. In some examples, aspects of the operations of 1320 may be performed by a transmission manager 735 as described with reference to FIG. 7.

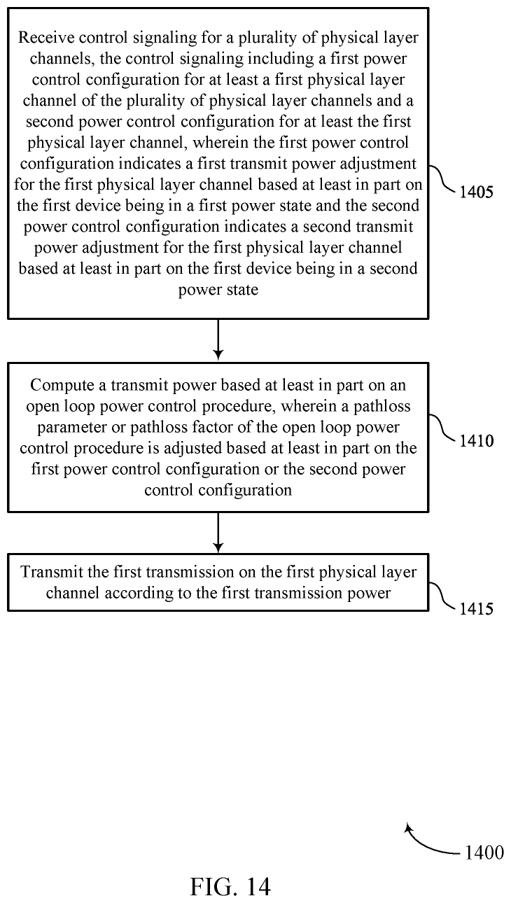

FIG. 14 shows a flowchart illustrating a method 1400 that supports power control configuration and signaling for communications with energy harvesting in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The operations of 1405 may be performed in accordance with examples as disclosed herein. In some examples, aspects of the operations of 1405 may be performed by a power state manager 725 as described with reference to FIG. 7.

At 1410, the method may include computing a transmit power based on an open loop power control procedure, where a pathloss parameter or pathloss factor of the open loop power control procedure is adjusted based on the first power control configuration or the second power control configuration. The operations of 1410 may be performed in accordance with examples as disclosed herein. In some examples, aspects of the operations of 1410 may be performed by an open loop power control manager 730 as described with reference to FIG. 7.

At 1415, the method may include transmitting the first transmission on the first physical layer channel according to the first transmission power. The operations of 1415 may be performed in accordance with examples as disclosed herein. In some examples, aspects of the operations of 1415 may be performed by a transmission manager 735 as described with reference to FIG. 7.

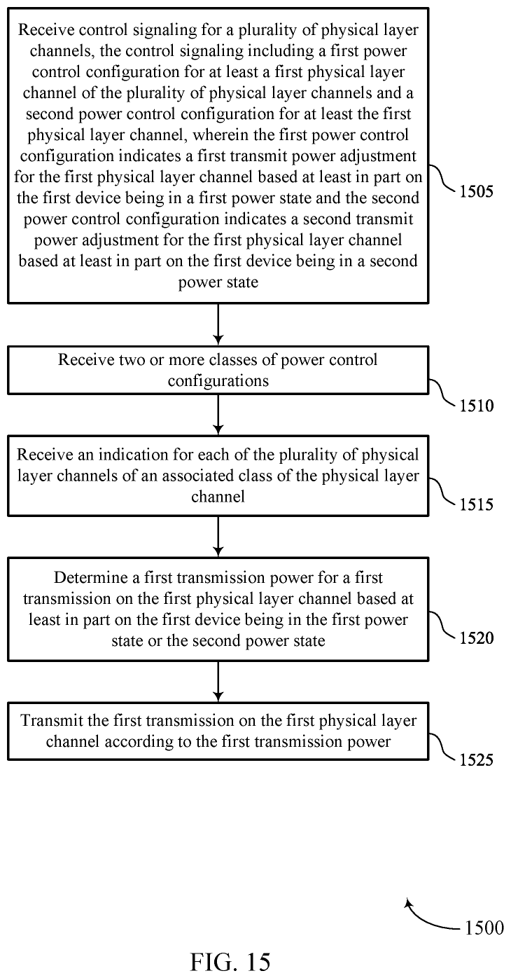

FIG. 15 shows a flowchart illustrating a method 1500 that supports power control configuration and signaling for communications with energy harvesting in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving control signaling for a set of multiple physical layer channels, the control signaling including a first power control configuration for at least a first physical layer channel of the set of multiple physical layer channels and a second power control configuration for at least the first physical layer channel, where the first power control configuration indicates a first transmit power adjustment for the first physical layer channel based on the first device being in a first power state and the second power control configuration indicates a second transmit power adjustment for the first physical layer channel based on the first device being in a second power state. The operations of 1505 may be performed in accordance with examples as disclosed herein. In some examples, aspects of the operations of 1505 may be performed by a power state manager 725 as described with reference to FIG. 7.

At 1510, the method may include receiving two or more classes of power control configurations. The operations of 1510 may be performed in accordance with examples as disclosed herein. In some examples, aspects of the operations of 1510 may be performed by an open loop power control manager 730 as described with reference to FIG. 7.

At 1515, the method may include receiving an indication for each of the set of multiple physical layer channels of an associated class of the physical layer channel. The operations of 1515 may be performed in accordance with examples as disclosed herein. In some examples, aspects of the operations of 1515 may be performed by an open loop power control manager 730 as described with reference to FIG. 7.

At 1520, the method may include determining a first transmission power for a first transmission on the first physical layer channel based on the first device being in the first power state or the second power state. The operations of 1520 may be performed in accordance with examples as disclosed herein. In some examples, aspects of the operations of 1520 may be performed by an open loop power control manager 730 as described with reference to FIG. 7.

At 1525, the method may include transmitting the first transmission on the first physical layer channel according to the first transmission power. The operations of 1525 may be performed in accordance with examples as disclosed herein. In some examples, aspects of the operations of 1525 may be performed by a transmission manager 735 as described with reference to FIG. 7.

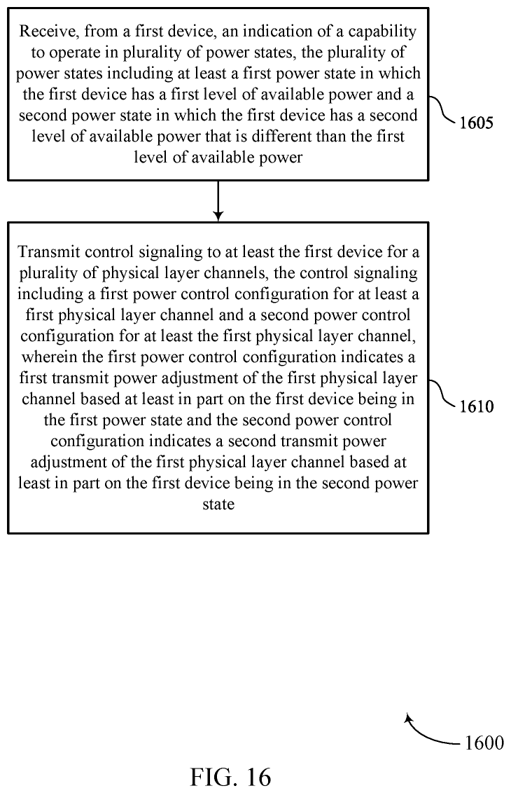

FIG. 16 shows a flowchart illustrating a method 1600 that supports power control configuration and signaling for communications with energy harvesting in accordance with aspects of the present disclosure. The operations of the method 1600 may be implemented by a UE or a base station or its components as described herein. For example, the operations of the method 1600 may be performed by a UE 115 as described with reference to FIGS. 1 through 8 or a base station 105 as described with reference to FIGS. 1 through 4 and 9 through 12. In some examples, a UE or a base station may execute a set of instructions to control the functional elements of the UE or the base station to perform the described functions. Additionally or alternatively, the UE or the base station may perform aspects of the described functions using special-purpose hardware.

At 1605, the method may include receiving, from a first device, an indication of a capability to operate in set of multiple power states, the set of multiple power states including at least a first power state in which the first device has a first level of available power and a second power state in which the first device has a second level of available power that is different than the first level of available power. The operations of 1605 may be performed in accordance with examples as disclosed herein. In some examples, aspects of the operations of 1605 may be performed by a power state manager 725 or a power state manager 1125 as described with reference to FIGS. 7 and 11.

At 1610, the method may include transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state. The operations of 1610 may be performed in accordance with examples as disclosed herein. In some examples, aspects of the operations of 1610 may be performed by an open loop power control manager 730 or an open loop power control manager 1130 as described with reference to FIGS. 7 and 11.

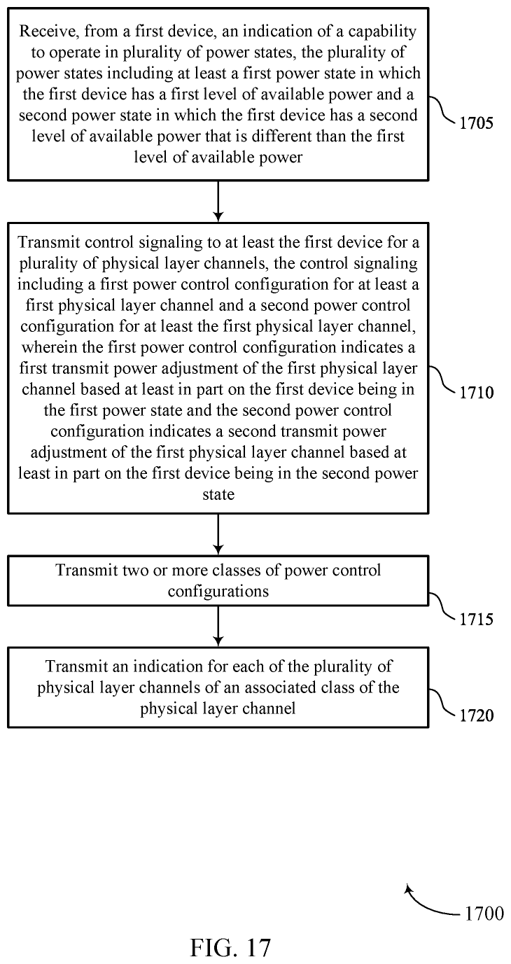

FIG. 17 shows a flowchart illustrating a method 1700 that supports power control configuration and signaling for communications with energy harvesting in accordance with aspects of the present disclosure. The operations of the method 1700 may be implemented by a UE or a base station or its components as described herein. For example, the operations of the method 1700 may be performed by a UE 115 as described with reference to FIGS. 1 through 8 or a base station 105 as described with reference to FIGS. 1 through 4 and 9 through 12. In some examples, a UE or a base station may execute a set of instructions to control the functional elements of the UE or the base station to perform the described functions. Additionally or alternatively, the UE or the base station may perform aspects of the described functions using special-purpose hardware.

At 1705, the method may include receiving, from a first device, an indication of a capability to operate in set of multiple power states, the set of multiple power states including at least a first power state in which the first device has a first level of available power and a second power state in which the first device has a second level of available power that is different than the first level of available power. The operations of 1705 may be performed in accordance with examples as disclosed herein. In some examples, aspects of the operations of 1705 may be performed by a power state manager 725 or a power state manager 1125 as described with reference to FIGS. 7 and 11.

At 1710, the method may include transmitting control signaling to at least the first device for a set of multiple physical layer channels, the control signaling including a first power control configuration for at least a first physical layer channel and a second power control configuration for at least the first physical layer channel, where the first power control configuration indicates a first transmit power adjustment of the first physical layer channel based on the first device being in the first power state and the second power control configuration indicates a second transmit power adjustment of the first physical layer channel based on the first device being in the second power state. The operations of 1710 may be performed in accordance with examples as disclosed herein. In some examples, aspects of the operations of 1710 may be performed by an open loop power control manager 730 or an open loop power control manager 1130 as described with reference to FIGS. 7 and 11.

At 1715, the method may include transmitting two or more classes of power control configurations. The operations of 1715 may be performed in accordance with examples as disclosed herein. In some examples, aspects of the operations of 1715 may be performed by an open loop power control manager 730 or an open loop power control manager 1130 as described with reference to FIGS. 7 and 11.

At 1720, the method may include transmitting an indication for each of the set of multiple physical layer channels of an associated class of the physical layer channel. The operations of 1720 may be performed in accordance with examples as disclosed herein. In some examples, aspects of the operations of 1720 may be performed by an open loop power control manager 730 or an open loop power control manager 1130 as described with reference to FIGS. 7 and 11.

The following provides an overview of aspects of the present disclosure:
Aspect 1: A method for wireless communication at a first device, comprising: receiving control signaling for a plurality of physical layer channels, the control signaling including a first power control configuration for at least a first physical layer channel of the plurality of physical layer channels and a second power control configuration for at least the first physical layer channel, wherein the first power control configuration indicates a first transmit power adjustment for the first physical layer channel based at least in part on the first device being in a first power state and the second power control configuration indicates a second transmit power adjustment for the first physical layer channel based at least in part on the first device being in a second power state: determining a first transmission power for a first transmission on the first physical layer channel based at least in part on the first device being in the first power state or the second power state; and transmitting the first transmission on the first physical layer channel according to the first transmission power.
Aspect 2: The method of aspect 1, wherein the first power state corresponds to a first energy harvesting mode of the first device, and the second power state corresponds to a second energy harvesting mode of the first device.
Aspect 3: The method of any of aspects 1 through 2, wherein the receiving the control signaling comprises: receiving, for each of the plurality of physical layer channels, a separate power control configuration for each of the first power state and the second power state.
Aspect 4: The method of aspect 3, wherein the control signaling is received in RRC signaling, in a medium access control (MAC) control element, in downlink control information, or in a shared channel message, received via an access link or a sidelink connection.
Aspect 5: The method of any of aspects 1 through 4, wherein the first power state and the second power state correspond to one or more of a battery level of the first device, an energy harvesting mode of the first device, a number of processes associated with sidelink or access link communications, or any combinations thereof.
Aspect 6: The method of any of aspects 1 through 5, wherein the first power control configuration and the second power control configuration each provide a positive power control offset, a negative power control offset, or no power control offset, to an open loop power control transmit power based at least in part on a power state of the first device.
Aspect 7: The method of any of aspects 1 through 6, wherein the control signaling is received from a serving base station, or from a primary UE of a sidelink connection at the first device.
Aspect 8: The method of any of aspects 1 through 7, wherein the determining comprises: computing a transmit power based at least in part on an open loop power control procedure, wherein a pathloss parameter or pathloss factor of the open loop power control procedure is adjusted based at least in part on the first power control configuration or the second power control configuration.
Aspect 9: The method of any of aspects 1 through 8, wherein a transmit power limit, a target transmit power, or any combinations thereof, are adjusted based at least in part on the first power control configuration or the second power control configuration, and wherein the transmit power limit and the target transmit power each have a different power control configuration.
Aspect 10: The method of any of aspects 1 through 9, further comprising: two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.
Aspect 11: The method of any of aspects 1 through 10, wherein receiving control signaling receiving two or more classes of power control configurations; and receiving an indication for each of the plurality of physical layer channels of an associated class of the physical layer channel.
Aspect 12: The method of any of aspects 1 through 11, wherein the control signaling is received from a serving base station and is associated with access link communications of the first device, or is associated with a pool of sidelink resources for sidelink communications between the first device and one or more other peer devices.
Aspect 13: The method of any of aspects 1 through 12, wherein the control signaling is received from a second device in a sidelink communication via a sidelink

RRC message, via sidelink medium access control (MAC) control element, via sidelink control information, or via a dedicated sidelink shared channel message.
Aspect 14: The method of any of aspects 1 through 13, further comprising: transmitting a request message to a second device that indicates one or more requested power control configurations for one or more of the plurality of physical layer channels and one or more power states of the first device.
Aspect 15: The method of any of aspects 1 through 14, wherein the first device communicates using sidelink communications with one or more other devices using the plurality of physical layer channels, and wherein a serving base station provides the control signaling for a pool of configured resources available for the sidelink communications.
Aspect 16: A method for wireless communication, comprising: receiving, from a first device, an indication of a capability to operate in plurality of power states, the plurality of power states including at least a first power state in which the first device has a first level of available power and a second power state in which the first device has a second level of available power that is different than the first level of available power; and transmitting control signaling to at least the first device for a plurality of physical layer channels, the control signaling including a first power control configuration for at least a first physical layer channel and a second power control configuration for at least the first physical layer channel, wherein the first power control configuration indicates a first transmit power adjustment of the first physical layer channel based at least in part on the first device being in the first power state and the second power control configuration indicates a second transmit power adjustment of the first physical layer channel based at least in part on the first device being in the second power state.
Aspect 17: The method of aspect 16, wherein the first power state corresponds to a first energy harvesting mode of the first device, and the second power state corresponds to a second energy harvesting mode of the first device.
Aspect 18: The method of any of aspects 16 through 17, wherein the transmitting the control signaling comprises: transmitting, for each of the plurality of physical layer channels, a separate power control offset for each of at least the first power state and the second power state.
Aspect 19: The method of any of aspects 16 through 18, wherein the first power state and the second power state correspond to one or more of a battery level of the first device, an energy harvesting mode of the first device, a number of processes associated with sidelink or access link communications, or any combinations thereof.
Aspect 20: The method of any of aspects 16 through 19, further comprising: two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.
Aspect 21: The method of any of aspects 16 through 20, wherein the transmitting the control signaling comprises: transmitting two or more classes of power control offsets; and transmitting an indication for each of the plurality of physical layer channels of an associated class of the physical layer channel.
Aspect 22: The method of any of aspects 16 through 21, wherein the first device communicates using sidelink communications with one or more other devices using the plurality of physical layer channels, and wherein the control signaling provides a pool of configured resources available for the sidelink communications.
Aspect 23: An apparatus for wireless communication at a first device, comprising a processor: memory coupled with the processor; and instructions stored in the memory and executable by the processor to cause the apparatus to perform a method of any of aspects 1 through 15.
Aspect 24: An apparatus for wireless communication at a first device, comprising at least one means for performing a method of any of aspects 1 through 15.
Aspect 25: A non-transitory computer-readable medium storing code for wireless communication at a first device, the code comprising instructions executable by a processor to perform a method of any of aspects 1 through 15.
Aspect 26: An apparatus for wireless communication, comprising a processor: memory coupled with the processor; and instructions stored in the memory and executable by the processor to cause the apparatus to perform a method of any of aspects 16 through 22.
Aspect 27: An apparatus for wireless communication, comprising at least one means for performing a method of any of aspects 16 through 22.
Aspect 28: A non-transitory computer-readable medium storing code for wireless communication, the code comprising instructions executable by a processor to perform a method of any of aspects 16 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first device, comprising:
a memory; and
a processor coupled with the memory and configured to:
receive control signaling for a plurality of physical layer channels, the control signaling including a first power control configuration for at least a first physical layer channel of the plurality of physical layer channels and a second power control configuration for at least the first physical layer channel, wherein the first power control configuration indicates a first transmit power adjustment for the first physical layer channel based at least in part on the first device being in a first power state and the second power control configuration indicates a second transmit power adjustment for the first physical layer channel based at least in part on the first device being in a second power state:
determine a first transmission power for a first transmission on the first physical layer channel based at least in part on the first device being in the first power state or the second power state; and
transmit the first transmission on the first physical layer channel according to the first transmission power.

2. The apparatus of claim 1, wherein the first power state corresponds to a first energy harvesting mode of the first device, and the second power state corresponds to a second energy harvesting mode of the first device.

3. The apparatus of claim 1, wherein the processor is further configured to:
receive, for each of the plurality of physical layer channels, a separate power control configuration for each of the first power state and the second power state.

4. The apparatus of claim 3, wherein the control signaling is received in radio resource control (RRC) signaling, in a medium access control (MAC) control element, in downlink control information, or in a shared channel message, received via an access link or a sidelink connection.

5. The apparatus of claim 1, wherein the first power state and the second power state correspond to one or more of a battery level of the first device, an energy harvesting mode of the first device, a number of processes associated with sidelink or access link communications, or any combinations thereof.

6. The apparatus of claim 1, wherein the first power control configuration and the second power control configuration each provide a positive power control offset, a negative power control offset, or no power control offset, to an open loop power control transmit power based at least in part on a power state of the first device.

7. The apparatus of claim 1, wherein the control signaling is received from a serving base station, or from a primary user equipment (UE) of a sidelink connection at the first device.

8. The apparatus of claim 1, wherein the processor is further configured to:
compute a transmit power based at least in part on an open loop power control procedure, wherein a pathloss parameter or pathloss factor of the open loop power control procedure is adjusted based at least in part on the first power control configuration or the second power control configuration.

9. The apparatus of claim 1, wherein a transmit power limit, a target transmit power, or any combinations thereof, are adjusted based at least in part on the first power control configuration or the second power control configuration, and wherein the transmit power limit and the target transmit power each have a different power control configuration.

10. The apparatus of claim 1, wherein two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.

11. The apparatus of claim 1, wherein the processor is further configured to:
receive two or more classes of power control configurations; and
receive an indication for each of the plurality of physical layer channels of an associated class of the physical layer channel.

12. The apparatus of claim 1, wherein the control signaling is received from a serving base station and is associated with access link communications of the first device, or is associated with a pool of sidelink resources for sidelink communications between the first device and one or more other peer devices.

13. The apparatus of claim 1, wherein the control signaling is received from a second device in a sidelink communication via a sidelink radio resource control (RRC) message, via sidelink medium access control (MAC) control element, via sidelink control information, or via a dedicated sidelink shared channel message.

14. The apparatus of claim 1, wherein the processor is further configured to:
transmit a request message to a second device that indicates one or more requested power control configurations for one or more of the plurality of physical layer channels and one or more power states of the first device.

15. The apparatus of claim 1, wherein the first device communicates using sidelink communications with one or more other devices using the plurality of physical layer channels, and wherein a serving base station provides the control signaling for a pool of configured resources available for the sidelink communications.

16. An apparatus for wireless communication, comprising:
a memory; and
a processor coupled with the memory and configured to:
receive, from a first device, an indication of a capability to operate in plurality of power states, the plurality of power states including at least a first power state in which the first device has a first level of available power and a second power state in which the first device has a second level of available power that is different than the first level of available power; and
transmit control signaling to at least the first device for a plurality of physical layer channels, the control signaling including a first power control configuration for at least a first physical layer channel and a second power control configuration for at least the first physical layer channel, wherein the first power control configuration indicates a first transmit power adjustment of the first physical layer channel based at least in part on the first device being in the first power state and the second power control configuration indicates a second transmit power adjustment of the first physical layer channel based at least in part on the first device being in the second power state.

17. The apparatus of claim 16, wherein the first power state corresponds to a first energy harvesting mode of the first device, and the second power state corresponds to a second energy harvesting mode of the first device.

18. The apparatus of claim 16, wherein the processor is further configured to:
transmit, for each of the plurality of physical layer channels, a separate power control offset for each of at least the first power state and the second power state.

19. The apparatus of claim 16, wherein the first power state and the second power state correspond to one or more of a battery level of the first device, an energy harvesting mode of the first device, a number of processes associated with sidelink or access link communications, or any combinations thereof.

20. The apparatus of claim 16, wherein two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.

21. The apparatus of claim 16, wherein the processor is further configured to:
transmit two or more classes of power control offsets; and
transmit an indication for each of the plurality of physical layer channels of an associated class of the physical layer channel.

22. The apparatus of claim 16, wherein the first device communicates using sidelink communications with one or more other devices using the plurality of physical layer channels, and wherein the control signaling provides a pool of configured resources available for the sidelink communications.

23. A method for wireless communication at a first device, comprising:
receiving control signaling for a plurality of physical layer channels, the control signaling including a first power control configuration for at least a first physical layer channel of the plurality of physical layer channels and a second power control configuration for at least the first physical layer channel, wherein the first power control configuration indicates a first transmit power adjustment for the first physical layer channel based at least in part on the first device being in a first power state and the second power control configuration indicates a second transmit power adjustment for the first physical layer channel based at least in part on the first device being in a second power state:
determining a first transmission power for a first transmission on the first physical layer channel based at least in part on the first device being in the first power state or the second power state; and
transmitting the first transmission on the first physical layer channel according to the first transmission power.

24. The method of claim 23, wherein the receiving the control signaling comprises:
receiving, for each of the plurality of physical layer channels, a separate power control configuration for each of the first power state and the second power state.

25. The method of claim 23, wherein the first power state and the second power state correspond to one or more of a battery level of the first device, an energy harvesting mode of the first device, a number of processes associated with sidelink or access link communications, or any combinations thereof.

26. The method of claim 23, wherein two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.

27. A method for wireless communication, comprising:
receiving, from a first device, an indication of a capability to operate in plurality of power states, the plurality of power states including at least a first power state in which the first device has a first level of available power and a second power state in which the first device has a second level of available power that is different than the first level of available power; and
transmitting control signaling to at least the first device for a plurality of physical layer channels, the control signaling including a first power control configuration for at least a first physical layer channel and a second power control configuration for at least the first physical layer channel, wherein the first power control configuration indicates a first transmit power adjustment of the first physical layer channel based at least in part on the first device being in the first power state and the second power control configuration indicates a second transmit power adjustment of the first physical layer channel based at least in part on the first device being in the second power state.

28. The method of claim 27, wherein the transmitting the control signaling comprises:
transmitting, for each of the plurality of physical layer channels, a separate power control configuration for each of at least the first power state and the second power state.

29. The method of claim 27, wherein two or more physical layer channels are grouped in a first channel group, and wherein the first power control configuration applies to each channel in the first channel group based at least in part on the first device being in the first power state, and the second power control configuration applies to each channel in the first channel group based at least in part on the first device being in the second power state.

30. The method of claim 27, wherein the transmitting the control signaling comprises:
transmitting two or more classes of power control configurations; and
transmitting an indication for each of the plurality of physical layer channels of an associated class of the physical layer channel.
